(19) United States
(12) Patent Application Publication
(10) Pub. No.: US 2025/0238741 A1
(43) Pub. Date: Jul. 24, 2025

(54) SPATIAL-TEMPORAL MULTI-TIMESCALE PREDICTIVE ANALYTICS WITH TIERED INTEGRATION OF QUEUING STRUCTURE

(71) Applicants: Purdue Research Foundation, West Lafayette, IN (US); The Trustees of Indiana University, Bloomington, IN (US)

(72) Inventors: Pengyi SHI, West Lafayette, IN (US); Jonathan HELM, Bloomington, IN (US)

(73) Assignees: Purdue Research Foundation, West Lafayette, IN (US); The Trustees of Indiana University, Bloomington, IN (US)

(21) Appl. No.: 19/035,312

(22) Filed: Jan. 23, 2025

Related U.S. Application Data
(60) Provisional application No. 63/624,421, filed on Jan. 24, 2024.

(51) Int. Cl. G06Q 10/0631

(52) U.S. Cl. CPC G06Q 10/06315

(57) ABSTRACT

A spatial-temporal predictive analytics system and method for time-series generation, forecasting, and predicting future resource needs across multiples forecast timescales and multiple physical locations. Examples of the system and method use a tiered integration approach to integrate one or more queuing structures with a generative artificial intelligence engine based on a given forecast timescale. The generative AI engine captures the highly complex, nonlinear spatial-temporal correlations often present in time-series data. Queuing network containing the queuing structures captures the underlying physical system dynamics and, at the various integration tiers, refines to varying degrees the generative AI engine with enhanced generation and prediction power, explainability, and interpolation. This tiered integration approach utilizes the strengths of both the generative AI engine and queuing theory and adapts predictions to ensure that the most relevant model drives the forecasting process at the various forecast timescales.

### CLAIM OF PRIORITY

This patent application claims the benefit of priority to U.S. Provisional Patent Application Ser. No. 63/624,421, filed Jan. 24, 2024, which is incorporated by reference herein in its entirety.

### TECHNICAL FIELD

Examples of the spatial-temporal predictive analytics system and method relate generally to the field of predictive analytics, and more particularly to allocation of resources and operational optimization in complex systems using a spatial-temporal predictive analysis that combines generative artificial intelligence (AI) and tiered integration of queuing structure.

### BACKGROUND

Time-series generation is helpful for using machines to make decisions in situations where there is a great deal of uncertainty. Time-series data is a series of measurements that are gathered over some time period, typically at equal intervals (such as daily or hourly). In general, time-series generation involves training a predictive model using an initial time-series dataset and then using the predictive model to generate similar (but original) time-series data that augments the initial time-series dataset. This augmented dataset can be used for testing and validating models, improving the accuracy of the predictive model, avoiding model overfitting based on limited observations, as well as for generating future scenarios for decision-making (e.g., demand scenarios for evaluating resource requirement level). These benefits are highly valuable within various domains. For example, generated synthetic data has been shown to significantly benefit healthcare and medicine fields, by addressing the concerns about data privacy and restricted data access limit, and thus boosting model comparisons and the development of new models. Other examples of time-series data include traffic flow, temperature, and electricity usage over time. Time-series generation can be used in a variety of scenarios including financial, industrial, and healthcare settings.

One type of time-series generation model is a probabilistic generative artificial intelligence (AI) model. A generative AI model uses neural networks to identify the patterns and structures within existing data (such as time-series data), learn the underlying probabilistic distribution, and then generate new and original content. In other words, the generative AI model trains extensive datasets, which then are then used to generate new data samples following the learned patterns. Generative AI models can capture complex patterns, including complex spatial-temporal correlations that traditional time-series models find difficult to capture, in time-series data, which leads to more accurate predictions. And combining the generative AI model with time-series generation allows the model to generate synthetic data and fill in any missing data, thus allowing the initial time-series dataset to become more comprehensive and thus help the generative AI model and its downstream prediction module to provide more accurate predictions.

### BRIEF DESCRIPTION OF THE DRAWINGS

To easily identify the discussion of any particular element or act, the most significant digit or digits in a reference number refer to the figure number in which that element is first introduced.

FIG. 1 is a schematic diagram of a spatial-temporal predictive analytics system according to some examples of this disclosure.

FIG. 2 is a schematic diagram of the details of the generative artificial intelligence (AI) engine shown in FIG. 1 according to some examples of this disclosure.

FIG. 3 is a flowchart illustrating operation of the spatial-temporal predictive analytics system according to some examples of this disclosure.

FIG. 4 is a flowchart illustrating operation of the spatial-temporal predictive analytics system according to the examples of this disclosure when the application is a healthcare setting.

FIG. 5 illustrates a diagrammatic representation of a machine in the form of a computer system within which a set of instructions may be executed for causing the machine to perform any one or more of the methodologies discussed herein, according to some examples of this disclosure.

FIG. 6 illustrates an original generation view of some examples of the generative artificial intelligence (AI) engine shown in FIG. 1.

FIG. 7 illustrates a cumulative difference learning view of some examples of the generative AI engine shown in FIG. 1.

### DETAILED DESCRIPTION

The following description of examples of a spatial-temporal predictive analytics system and method is not intended to be limited to these examples, but rather to enable any person skilled in the art to make and use the systems and methods described herein.

### General Overview

Examples of the spatial-temporal predictive analytics system and method generate and predict time-series data corresponding to future resource needs across multiples timescales and across multiple physical locations. In general, this helps leaders to make decisions about the allocation of resources (or resource allocation) based on resource demand. Resource demand is the number of units requiring attention, such as patients needing care or merchandise needing shelf space. Examples of the system and method addresses challenges in dynamically planning and allocating resource needs within complex systems (such as healthcare networks) by generating future scenarios and predicting future resource requirements across multiple locations and for multiple timescales, where there are complex, unknown spatial-temporal correlations. This is achieved in part by a gradual integration of one of more queuing structures (modeling one or more spatial components) into a generative prediction model. The generative prediction model is obtained using a generative-AI based predictive analysis technique. It should be noted that examples of the system and method include highly complex, nonlinear spatial-temporal correlations, which typically is missing from existing time-series prediction techniques.

Examples of the system and method use generative AI techniques (deep generative learning) combined with queuing theory in an innovative way. Examples of the system and method accommodate the dynamic nature of complex environments and provide accurate and timely predictions based on both spatial and temporal information. These predictions, in some examples, are used for decision making about where to allocate resources for a network of facilities distributed among different geographical locations based on resource demand over future time periods with different lengths (e.g., several hours, weeks, or months) or forecast timescales.

In queuing theory, a “queuing structure” includes a specific organization or arrangement of a queue and the mechanics of how a queue operates within a system. This may include how items are added to the queue, how they are served, rules governing the order in which they get served, and the capacity of the queue. Examples of queuing structures include a single-server queue with first-in first-out (FIFO) discipline, where a single server services items in the order they arrive, and a multi-server queue with priority discipline, where multiple servers service items and where certain items are prioritized based on specific criteria.

A distinctive feature of examples of the spatial-temporal predictive analytics system and method is a gradual (or “tiered”) integration approach of one or more queuing structures into a generative prediction model. This tiered integration of queuing structures (or “tiered queuing”) applies different levels of queuing structures into the generative prediction model based on a given forecast timescale (such as quarterly, monthly, weekly, daily, and hourly) to support decision making at different levels (such as tactical, strategical, and operational). For example, these integration tiers can include less (or minimal) integration of queuing structures into the generative prediction model for longer forecast timescales (such as quarterly or monthly forecast timescales) and greater (or full) integration of queuing structures into the generative prediction model for shorter forecast timescales (such as an hourly forecast timescale). This means that for a monthly/quarterly integration tier the queuing structure is minimally integrated into the generative artificial intelligence engine. For the weekly/daily integration tier the queuing structure is moderately integrated into the generative artificial intelligence engine. And for the hourly integration tier the queuing structure is fully integrated into the generative artificial intelligence engine.

As used in this context, the fully integrated means that all or nearly all the queuing structure is integrated, minimally integrated means that much less than all of the queuing structure is integrated, and moderately integrated means that somewhere between all and none of the queuing structure is integrated. In other words, fully integrated is the most integration, minimally integrated is the least integration, and moderately integrated is somewhere between fully integrated and minimally integrated.

This sets the spatial-temporal predictive analytics system and method apart from existing predictive technologies and moves from existing pure “black box” prediction to this system and method that considers how the real physical world behaves. Because the queuing structures based on queuing theory capture the underlying system dynamics, this innovative approach provides both accuracy and interpretability. Moreover, examples of the spatial-temporal predictive analytics system and method provide an interpolation ability to predict patterns that were not observed in the past, which is an ability that pure machine learning models lack.

The queuing structures capture the underlying dynamics of a physical system, as the generative prediction model transitions from long-term to short-term forecasting, to support the corresponding multi-tiered decision making. Tiered integration of queuing structures into machine learning prediction is pivotal. This allows examples of the spatial-temporal predictive analytics system and method to predict the flow of resources through various stages and at various physical locations of the operational process. By modeling the intricacies of queuing structures, such as arrival rates, service rates, and the behavior of resources in queues, examples of the system and method can predict potential bottlenecks and suggest preemptive allocations to maintain operational efficiency.

In some examples, the spatial-temporal predictive analytics system and method use three layers of decision making to determine resource allocation. Specifically, a first layer relates to a monthly or quarterly forecast timescales, where some examples of the system and method analyze historical data to identify patterns and establish baseline resource demands. A second layer relates to weekly or daily forecast timescale predictions, where some examples of the system and method begin to integrate more immediate variables that represent the inflow/outflow dynamics of the underlying physical (or queuing) system. This second layer fine tunes the forecasts with increased precision. A third layer relates to an hourly forecast timescale, where some examples of the spatial-temporal predictive analytics system and method employ one or more sophisticated queuing structures within its generative machine learning models.

Examples of the spatial-temporal predictive analytics system and method offer a versatile foundation for capturing complex correlation structures. Thus, examples of the system and method are generally applicable across various domains, including healthcare (such as forecasting patient admissions, and predicting staffing needs and resource allocation in hospitals), finance (such as predicting stock market trends and optimizing investment strategies), traffic management (such as predicting and managing traffic volume), retail (such as forecasting demand for inventory and managing the inventory), and energy collection (such as predicting energy consumption and optimizing energy production).

Existing methods fall short in addressing the challenges of predictive analysis and time-series generation that are pervasive in many of the applications listed above. The main challenges are: (i) that errors tend to accumulate over time due to generation in an autoregressive/recursive manner; (ii) general-purpose (non-domain specific) generative methods often ignore problem structure and lack theoretical justification or interpretability; and (iii) that pure machine-learning based models lack capturing the real physical system and cannot interpolate for scenarios that were not seen in historical data.

The time series observations are often driven by unobserved variables with complex interactions in various domains. For instance, in the healthcare setting, the daily hospital census is driven by daily patient arrivals (in other words, the patient inflow) and transfers and discharges (in other words, the patient outflow). The arrivals and discharges are correlated, both over time and across different geographical locations, resulting in highly complex spatial-temporal correlations in the census. General-purpose methods either rely on step-wise learning (causing the issue (i) above) or otherwise impose assumptions on spatial-temporal correlation structures in the time series observations, which might inadequately capture the complexities. Disregarding the dynamics of the underlying physical systems and the interactions between the unobserved and observed variables may also risk misinterpreting the true drivers behind the time-series patterns and thereby affect decision-making.

### System Details

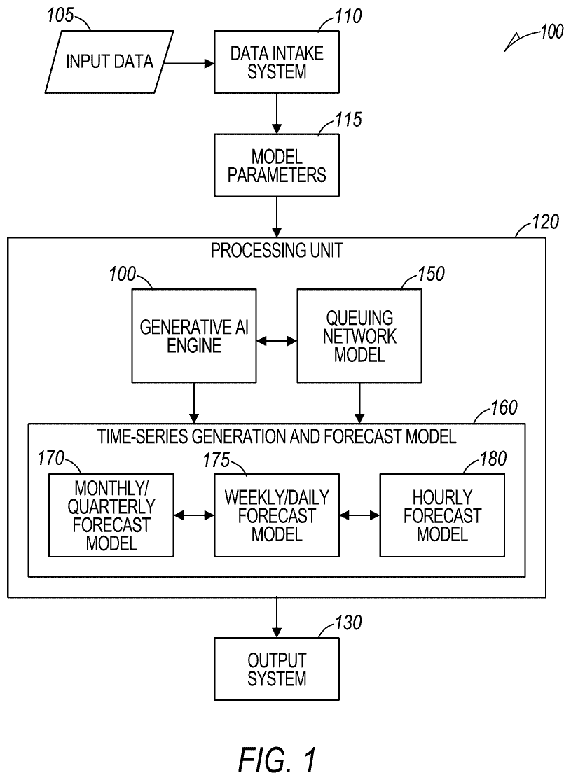

FIG. 1 is a schematic diagram of a spatial-temporal predictive analytics system 100 according to some examples of this disclosure. The system 100 is designed to provide a comprehensive solution for the complex task of resource allocation optimization. As shown in FIG. 1, some examples of the spatial-temporal predictive analytics system 100 include a data intake system 110, a processing unit 120, and an output system 130.

The data intake system 110 converts input data 105 from various data sources into model parameters 115. The processing unit 120 uses these model parameters 115 in some examples for training and learning. The data intake system 110 collects and processes the input data 105 from a variety of different sources. This also includes processing input data 105 from a plurality of physical locations. In some examples, this input data 105 includes historical operational data including resource capacities, time-stamped entries of resource requests, and average time for dealing with a request.

The data intake system 110 then converts the collected input data 105 into aggregate statistics. In some examples, these aggregate statistics include the average inflow and the average outflow to different physical locations at different timescales (such as hourly, weekly, or monthly). In some examples, the average inflow is the average daily patient inflow into a hospital or medical facility while the average outflow is the average daily patient outflow from the hospital or medial facility. Other relevant metrics that can influence predictive models are also included in some examples and can be tailored to different systems. In addition, the data intake system 110 also cleans, sorts, and structures the input data 105 in preparation for sending the input data 105 to the processing unit 120.

The processing unit 120 includes a predictive analytics engine (shown in FIG. 1 as a generative artificial intelligence (AI) engine 140), a queuing network model 150, and a time-series generation/forecast model 160. Central to the processing unit 120 is the generative AI engine 140, which uses one or more predictive analytics techniques. In some examples the predictive analytics technique is a generative AI technique. In these examples, the generative AI engine 140 uses advanced probabilistic-based, deep-learning generative AI techniques to learn the distribution from the input data 105 of a plurality of physical locations that are spatially-temporally correlated. The generative AI engine 140 learns the resource demand from the input data 105 using the deep generative AI techniques and from that learning generates predictive data and recommendations for the allocation of resources.

In some examples, the generative AI engine 140 uses a temporal variational auto-encoding (VAE) that leverages a unique cumulative difference learning mechanism. In the cumulative difference learning mechanism, the cumulative difference is the summation of the difference between inflow and outflow over a given forecast time horizon using a proper timescale. This learning mechanism can effectively avoid the error accumulation issue that is prevalent in existing time-series generation and forecast models.

The processing unit 120 also includes a queuing network model 150. The queuing network model 150 applies sophisticated queuing theory techniques to generate one or more of the queuing structures that simulate and predict the status of resources as they move through different service stages. By way of example, this may include calculating likely wait times, service completion rates, utilization rates at different locations, and the impact of these factors on overall resource deployment. The collection of these separate or interconnected queuing structures is a queuing network.

One of the unique aspects of the processing unit 120 is the “tiered integration” of the queuing structures from the queuing network model 150 into the generative AI engine 140. As discussed in detail below, the queuing structures are integrated into the generative AI engine 140 in a tiered manner and the resultant integration provides simulations and predictions of a status of resources for a plurality of service stages across the plurality of physical locations.

More specifically, the queuing network model 150 first maps out the physical locations and service stages relevant to the operational environment. For example, in a healthcare setting the physical locations may be different hospital units. Next, key queuing parameters for each service stage and physical location are identified. In the healthcare example, these key queuing parameters may include arrival patterns of patients, service times, and resource availability. These key queuing parameters are customized based on the specific operational needs and historical data patterns of the environment. Then the queuing network is constructed, linking the different service stages and locations in a way that reflects their real-world interdependencies and patient or resource flow. Finally, this queuing network is used to run simulations, which constitutes the output for the queuing network model 150.

The tiered integration of the queuing network model 150 into the generative AI engine 140 means that based on the forecast timescale (such as from monthly prediction to hourly integration), examples of the spatial-temporal predictive analytics system 100 leverages information from the queuing network model 150 differently. The tiered integration adapts to different timescales. These various timescales can include one or more of: (1) quarterly; (2) monthly; (3) weekly; (4) daily; (5) hourly.

### Tiered Integration Approach

As shown in FIG. 1, in some examples the tiered integration of the queuing network model 150 and the generative AI engine 140 yields the time-series generation and forecast model 160, which provides predictions across multiple timescales. In some examples of the spatial-temporal predictive analytics system 100, the first integration tier is a monthly/quarterly integration tier (with minimal queuing network model 150 integration into the generative AI engine 140), a second integration tier is a weekly/daily integration tier (with moderate queuing network model 150 integration), and a third integration tier is an hourly integration tier (with full queuing network model 150 integration). The time-series generation and forecast model 160 implements this tiered integration of queuing structure (or queuing network model 150) to provide various levels of integration based on the forecast timescale in use.

In some examples, the time-series generation and forecast model 160 includes a monthly/quarterly forecast model 170 (using the monthly/quarterly integration tier having a minimal integration of the queuing network model 150 integration into the generative AI engine 140), a weekly/daily forecast model 175 (using the weekly/daily integration tier having a moderate integration of the queuing network model 150 into the generative AI engine 140), and an hourly forecast model 180 (using the hourly integration tier having a full integration of the queuing network model 150 into the generative AI engine 140). In other examples of the spatial-temporal predictive analytics system 100, additional forecast timescales and other levels or tiers of integration (integration tiers) are used.

### Monthly/Quarterly Tiered Integration

At the monthly and quarterly prediction level, there is minimal queuing structure integration into the generative AI engine 140, and the generative AI engine 140 primarily drives the forecasting. In other words, the monthly/quarterly forecast model 170 uses minimal knowledge from the queuing network model 150 and mainly relies on the generative AI engine 140. The queuing network model 150 is used primarily to provide basic insights into overall resource utilization patterns and long-term trends. The generative AI engine 140 utilizes historical data to learn trends and patterns and to make long-term predictions.

The monthly/quarterly forecast model 170 is used for identifying monthly or quarterly patterns of resource demand across the plurality of physical locations. Resource demand refers to the number of units that need to be placed at any of the plurality of physical locations. For example, when used in a healthcare setting, a unit is a patient and resource demand refers to the number of patients that need healthcare. This patient demand can be serviced across a plurality of medical facilities, such as hospitals, with a geographic area or within a healthcare network. The monthly/quarterly forecast model 170 identifies broad trends and patterns to establish a baseline for resource needs. The monthly/quarterly forecast model 170 is trained with historical data with a focus on identifying monthly and quarterly seasonality patterns. Generated sample paths learned based on historical data are averaged to provide the estimated mean and standard deviation over the monthly or quarterly forecast timescale.

### Weekly/Daily Tiered Integration

As the prediction scale shifts to a weekly or daily basis, the integration of the queuing structure into the generative AI engine 140 becomes more pronounced. The weekly/daily forecast model 175 is for predicting weekly or daily patterns of resource demand across the plurality of physical locations. When moving to the weekly/daily forecast model 175, the generative AI engine 140 is refined by incorporating the information from the queuing network model 150 and additional real-time input data.

The queuing network model 150 helps to calculate the initial census of resources (like staff or equipment availability) and integrates more real-time data elements. The weekly/daily forecast model 175 uses the range of possible initial census calculated from the queuing network model 150 to generate corresponding time-series data starting from each initial census and provide forecast of future resource needs. Each of these initial censuses is calculated based on the inflow, which identifies the daily inflow of units over a week or several weeks to the plurality of physical locations, as well as the outflow, which identify the daily outflow of units over a week or several weeks from the plurality of physical locations, in the queuing network model 150. These initial censuses refine the predictive data generated from the weekly/daily forecast model 175, providing the confidence interval based on the range of the initial census and more accurate recommendations for the allocation of resources. The inflow-outflow census calculation also refines the design of input data transformation and output generation structures of the generative AI engine 140 for the weekly/daily forecast module 175.

### Hourly Tiered Integration

At the hourly prediction timescale, the queuing network model 150 becomes the primary driver for predictions. The queuing network model 150 actively predicts resource demand at different physical locations for the next few hours, based on the real-time census and predicted inflow and outflow to each physical location. The hourly forecast model 180 is for identifying hourly patterns of resource demand across the plurality of physical locations. The hourly level of prediction relies heavily on real-time data and uses the queuing network model 150 to dynamically adjust to immediate changes in resource needs and patient flow. The generative AI engine 140 supports these predictions by providing advanced analytics on the arrival and departure predictions (which incorporated the spatial-temporal correlations), enhancing the accuracy of short-term forecasts. In particular, the queuing network model 150 in conjunction with the generative AI engine 140 uses simulation techniques and observed system state along with planned inflow and outflow information in a forecast timescale of the next few hours to capture the flow and usage of resources at the most granular level in real-time.

The tiered integration approach to integrating the one or more queuing structures from the queuing network model 150 into the generative AI engine 140 based on the forecast timescale ensures that, at each forecast timescale (quarterly, monthly, weekly, daily, and hourly), examples of the system 100 effectively utilize the strengths of both the generative AI engine 140 and the queuing network model 150. As a result, examples of the system 100 adapt predictions based on the forecast timescale, ensuring that the most relevant model drives the forecasting process at each stage.

The output system 130 presents the predictive data and the recommendations for the allocation of resources. Some examples of the spatial-temporal predictive analytics system 100 include a recommendation interface. In this case, the output of the system 100 is channeled through a user-friendly user interface that presents the predictive data and recommendations for resource allocation. This user interface enables decision-makers to visualize forecasts, understand potential resource bottlenecks, and receive suggestions for optimal resource allocation. Additionally, some examples of the system 100 generate automated alerts and reports to notify managers of critical high utilization or congestion levels and comprehensive reports that provide insights into operational efficiency and potential areas for improvement.

Examples of the spatial-temporal predictive analytics system 100 are designed with modularity in mind. This means that each component of the system 100 can be updated independently to adapt to new data sources, analytical methods, or operational requirements. The architecture of the system 100 is scalable, ensuring that as the needs of an organization grow, the system 100 can grow with them without the need for an entire system overhaul.

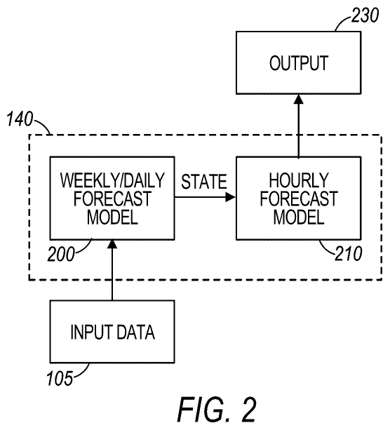

FIG. 2 is a schematic diagram of the details of the generative AI engine 140 shown in FIG. 1 according to some examples of this disclosure. As shown in FIG. 2, the generative AI engine 140 includes an encoder 200 and a decoder 210. The encoder 200 is used for breaking down the input data 105 into its core components (projection into the latent space). Moreover, the encoder 200 uses the cumulative difference learning mechanism to identify patterns across the plurality of physical locations and multiple timescales.

The generative AI engine 140 also includes a decoder 210. The decoder 210 is used for generating the predictive data from the latent space and the recommendations for the allocation of resources using the patterns across the plurality of physical locations and multiple timescales. The decoder 210 translates the information extracted from the encoder 200 into some similar, but new, information.

For the weekly/daily forecast model 175, the inflow and the outflow queuing structure is used to design the encoder 200 and the decoder 210 in the generative AI engine 140. In this manner the queuing network model 150 influences the design of the generative AI engine 140. The design of the encoder 200 and decoder 210 within the generative AI engine 140 incorporates queuing theory principles (such as, for example, the census on day t=initial census+cumulative arrivals−cumulative departures) from the queuing network model 150. This allows for a better understanding of resource flow and the real dynamics of the physical system.

As noted above, in some examples the generative AI engine 140 uses a temporal variational auto-encoding (VAE) that leverages a unique cumulative difference learning mechanism. In these examples, both the encoder 200 and the decoder 210 of the VAE are parameterized with recurrent neural networks to capture the spatial-temporal correlations. In addition, when the timescale uses the monthly/quarterly forecast model 170, the structures used in the encoder 200 and decoder 210 are kept at a coarse level (with simple linear functional form), which reduce the generative AI model to be like an auto-regressive time-series model forecast. When the timescale uses the weekly forecast model 175, the encoder and decoders are refined with recurrent neural networks that incorporate the inflow and the outflow structures and that are mathematically justified.

### Operational Overview

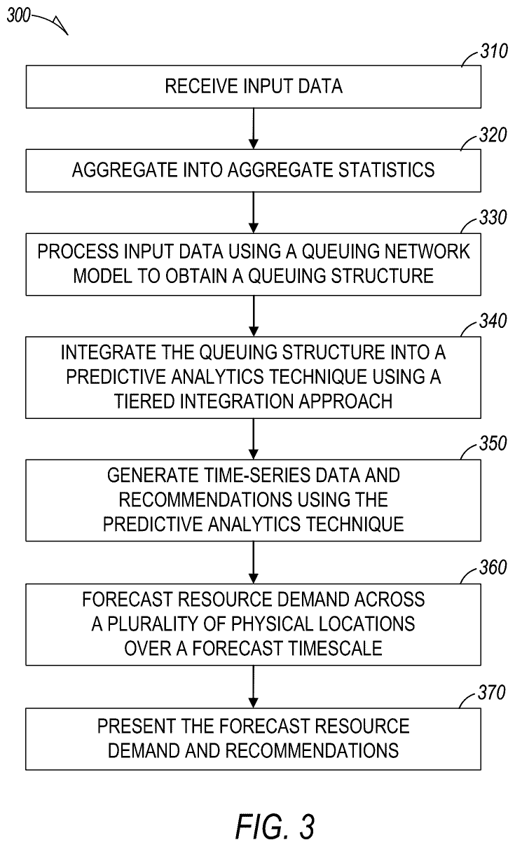

FIG. 3 is a flowchart 300 illustrating operation of the spatial-temporal predictive analytics system 100 according to some examples of this disclosure. The flowchart 300 commences a method of predicting an allocation of resources at operation 310 by receiving input data. In some examples, the input data contains relevant metrics about resource demand and resource capacity. In operation 320, the flowchart 300 aggregates the input data into aggregate statistics. These aggregate statistics, in some examples, include an inflow of units and an outflow of the units over the plurality of physical locations.

Input data is processed in operation 330 using the queuing network model 150 to obtain a queuing structure. In operation 340, the flowchart 300 uses a tiered integration approach to integrate the queuing structure into a predictive analytics technique. In some examples, the predictive analytics technique is a generative artificial intelligence (AI) technique. In other examples, the predictive analytics technique uses temporal variational auto-encoding (VAE) that leverages a cumulative difference learning mechanism. In these cases, the cumulative difference is a summation of the difference between an inflow of the units and an outflow of the units over a forecast time period with proper timescale. In some examples, the flowchart 300 uses the predictive analytics technique to learn the allocation of resources from the input data and the queuing structure. In these examples, the input data has spatially-temporally correlation across the plurality of physical locations (spatial) and different time points in a given time period (temporal).

The flowchart 300 then generates time-series data and a recommendation for the allocation of resources across a plurality of physical locations, in operation 350. This generation is made using the input data and the queuing structure and the predictive analytics technique. Operation 360 includes making a forecast about the resource demand across the plurality of physical locations. This is done at a forecast timescale and the corresponding integration tier. This forecast timescale is at least one of: (a) a monthly or quarterly forecast timescale; (b) a weekly or daily forecast timescale; (c) an hourly forecast timescale. The flowchart 300 concludes in operation 370 by presenting forecasted resource demand and a recommendation for the allocation of resources across the plurality of physical locations for one the forecast timescales (monthly, quarterly, weekly, daily, and hourly).

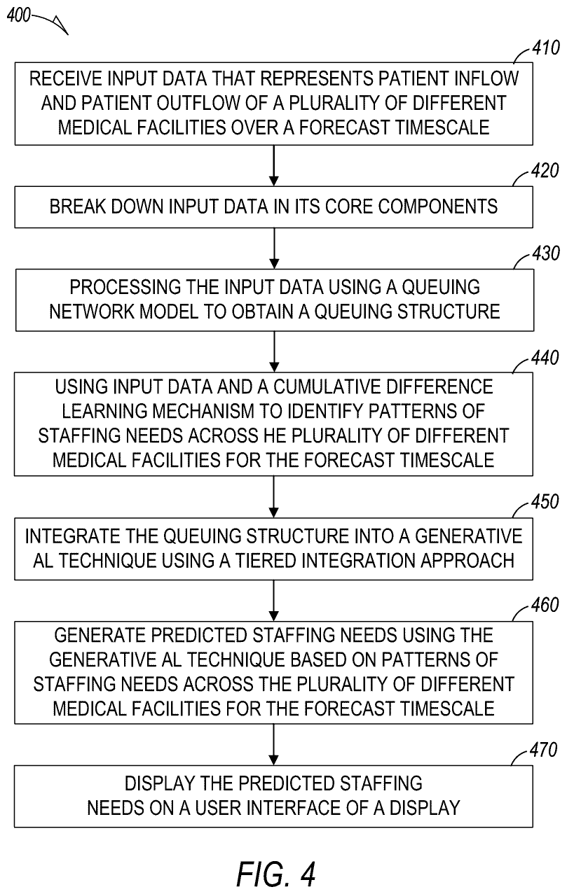

FIG. 4 is a flowchart illustrating operation of the spatial-temporal predictive analytics system 100 according to the examples of this disclosure when the application is a healthcare setting. In some examples of the healthcare setting, units are patients, a plurality of physical locations are a plurality of different medical facilities (such as hospitals), and resources includes nurses, doctors, and other staff and healthcare workers.

The flowchart 400 predicts future staffing needs across a plurality of different medical facilities and for a forecast time period with proper timescale (or forecast timescale). The flowchart 400 begins at operation 410 by receiving input data from a variety of data sources. In some examples, the input data represents a patient inflow into and a patient outflow out of each of the plurality of different medical facilities over the forecast time period with proper timescale. In operation 420, the flowchart 400 breaks down (or decomposes) the input data into its core components. This is performed using a cumulative difference learning mechanism to identifying patterns of staffing needs across the plurality of different medical facilities and for the forecast time period with proper timescale. The cumulative difference learning model uses a cumulative difference, which is the cumulative difference is a summation of the difference between the patient inflow and the patient outflow over the forecast time period with proper timescale.

The flowchart 400 continues at operation 430 by processing the input data using the queuing network model 150 to obtain a queuing structure. In operation 440, the flowchart 400 uses the input data and the cumulative difference learning mechanism to identify patterns of staffing needs across the plurality of medical facilities for the forecast time period with proper timescale.

In some examples, the flowchart 400 identifies weekly patterns of patient demand across the plurality of medical facilities using a weekly forecast model. In these examples the forecast timescale is weekly. In other examples, the flowchart 400 identifies hourly patterns of patient demand across the plurality of medical facilities using an hourly forecast model. In these examples, the forecast timescale is hourly. It is also possible that the forecast timescale can be multiple forecast timescales, such as a weekly forecast timescale and an hourly forecast timescale.

In operation 450, the flowchart 400 then integrates the queuing structure into the generative AI technique using a tiered integration approach (as discussed above). Operation 460 includes generating predicted staffing need using the generative AI technique. For example, the monthly forecast timescale predicts long-term staffing needs such as the number of new nurses or travel nurses to hire. The weekly forecast timescale predicts medium-term staffing needs such as the number of resource nurse to deploy/relocate from one location to another location. The hourly forecast timescale predicts immediate staffing needs in different care units within a hospital, allowing charge nurses to move nurses around these units. This generation is based on the patterns of staffing needs across the plurality of different medical facilities for the forecast period with different timescale. Finally, in operation 470, the flowchart 400 displays the predicted staffing needs on a user interface of a display.

### Operational Details

The operational details of examples of the spatial-temporal predictive analytics system and method are described as follows. Mathematically, the problem is defined as a collection of random variables that form a timeseries sequence {Xₜ, t=0, 1, . . . , T} with the length of T+1. This this sequence is denoted as X_{0:T}. The training dataset D consists of N observed sequences, denoted as:

$$D = \{ {x}_{0 \text{?} T}^{( 1 )} , … , {x}_{0 \text{?} T}^{( N )} \} . \qquad ( 1 )$$

$$\text{?} \text{indicates text missing or illegible when filed}$$

For a given sequence, the observation at time t, xₜ, is a vector in Rₖ, where k is the feature space dimension. Going forward, N and k will be omitted unless explicitly mentioned. The objective is to learn the joint distribution p(X_{0:T}) from the training data.

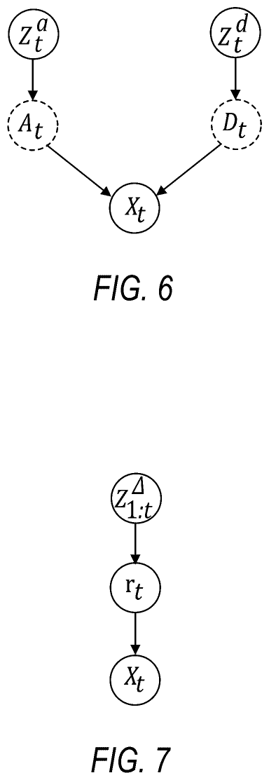

The dependency structure between the latent variables and observations of the generative modeling framework is summarized in FIGS. 6 and 7. FIG. 6 illustrates an original generation view of some examples of the generative AI engine 140 shown in FIG. 1. Referring to FIGS. 6, Zₜ^{a} and Z_{T}^{d} are the latent variables, Aₜ are the inflow variables, Dₜ are the outflow variables, and Xₜ are the random variables.

FIG. 7 illustrates a cumulative difference learning view of some examples of the generative AI engine 140 shown in FIG. 1. Referring to FIG. 7, Z_{1:t}^{Δ} are the latent variable sequence, Γₜ is the cumulative difference term, and Xₜ are the random variables.

Mathematically, the dependency structure between the latent variables and observations are specified as follows. It is assumed that each random variable Xₜ is driven by the previous random variable Xₜ₋₁, an “inflow” variable Aₜ, and an “outflow” variable Dₜ. The relationship of Xₜ, Xₜ₋₁, Aₜ, and Dₜ is described as:

$${X}_{\text{?}} \vert {X}_{t - 1} , {A}_{\text{?}} , {D}_{t} = {X}_{t - 1} + {A}_{t} - {D}_{t} + \text{?} , \qquad ( 2 )$$

$$t = 0 , … , T , ϵ ∼ N ( 0 , \text{?} ) ,$$

$$\text{?} \text{indicates text missing or illegible when filed}$$

where τ denotes the covariance matrix in the Gaussian distribution. Note that the noise may change over time as ϵt˜N(0, τt) with τt being time-varying. This formulation will continue with the fixed covariance matrix τ for now. Moreover, because the random variable Xₜ is dependent on other unobserved variables, Xₜ will be referred to as the “dependent variable.”

The inflow and outflow variables Aₜ and Dₜ are further driven by some underlying “environmental factors” {Zₜ}. The following dependence formulation is used, which is commonly used in deep latent Gaussian models and is a discretized version of stochastic differential equations (SDE) for variational inference in neural-SDE. The autoregressive updates capture how the inflow and outflow variables change over time, similar to the evolution of a diffusion process described by SDE.

$${A}_{0} = {a}_{0} ; {D}_{0} = {d}_{0} ; \qquad ( 3 )$$

$${A}_{t} = {A}_{t - 1} + {b}_{\text{?}} ( {A}_{t - 1} ) + {σ}_{\text{?}} {Z}_{t}^{a} , t = 1 , … , T ;$$

$${D}_{t} = {D}_{t - 1} + {b}_{d} ( {D}_{t - 1} ) + {σ}_{d} {Z}_{\text{?}}^{d} , t = 1 , … , T . \qquad ( 4 )$$

$$\text{?} \text{indicates text missing or illegible when filed}$$

Here, the sequences of latent variables:

Z₁^{a}, . . . , Z_{T}^{a}˜^{iid} [symbol] (0, Iₖ)

and

Z₁^{d}, . . . , Z_{T}^{d}˜^{iid} [symbol] (0, Iₖ)

are all independent and identically distributed (i.i.d.) standard Gaussian vectors in Rₖ. The drift function bₐ(·) and b_{d}(·) and diffusion terms σₐZₜ^{a} and σ_{d}Zₜ ^{d} drive the inflow and outflow processes and the temporal correlations. Additionally, it can integrate spatial correlations via the diffusion terms σₐZₜ^{a} and σ_{d}Zₜ ^{d} depending on the application domains.

The formulation in equations (2), (3), and (4) is generally applicable in various domains. By way of example and not limitation, here are a few examples to illustrate the applicability. In a healthcare setting, Xₜ corresponds to the daily patient census, or the count of hospitalized patients in a specific hospital unit, county, or region on day t. The census changes with daily patient arrivals Aₜ and discharges Dₜ. In a traffic management setting, Xₜ corresponds to the volume of traffic flow at time t, which is determined by incoming vehicles Aₜ and outgoing vehicles Dₜ. In an energy sector scenario, Xₜ signifies the observed energy volume at time t. This amount is driven by the newly collected energy Aₜ and energy loss or consumption Dₜ. In a law enforcement setting, Xₜ for crime incidents can be interpreted similarly.

The parameters to be learned include those parametrizing the drift and the diffusion terms. This learning task poses challenges since the inflow and outflow variables are often absent in observed datasets and only values of Xₜ are recorded. In other words, one cannot directly learn the parameters from inflow variable {Aₜ} and outflow variable {Dₜ} but need to learn from {Xₜ} via the dependence structures given in equations (2), (3), and (4).

### Cumulative Difference Learning

Beyond the unobserved inflow and outflow variables, a key challenge arises from the accumulation of errors. A common approach to learning the joint distribution of Xₜ within the generative modeling framework is through step-wise learning, specifically, learning the conditional distribution Xₜ|X_{0:t-1}. However, this approach encounters a prominent challenge, which is for each time step, I<T, a highly inaccurate estimation of the dependent variable Xₜ results in considerable deviations in the estimation of all subsequent values from I+1 to time T. This is due to the recursive nature of step-wise learning, where the calculation of the dependent variable Xₜ depends on Xₜ₋₁. In simpler terms, errors accumulate over time, and their effect on the dependent variable amplifies significantly for more distant future time points.

To overcome this issue, some examples of the spatial-temporal predictive analytics system and method use a novel cumulative difference learning scheme, specified as follows. First, the system and method define a new variable that captures the cumulative difference:

$${Γ}_{t} = {\sum }_{i = 1}^{\text{?}} {Δ}_{i} = {\sum }_{i = 1}^{\text{?}} {A}_{i} - {\sum }_{i = 1}^{\text{?}} {D}_{i} . \qquad ( 5 )$$

$$\text{?} \text{indicates text missing or illegible when filed}$$

Here, Δt=Aₜ-Dₜ represents the difference between inflow and outflow variables Aₜ and Dₜ (in other words, the changes in Xₜ's from Xₜ₋₁'s), and Γₜ represents the cumulative difference (or the net changes in Xₜ's). In the training dataset, this cumulative difference can be observed by Yₜ=xₜ−x₀ (with measurement errors). This new relationship between X₀, Xₜ, and Γₜ can be described as follows:

$${X}_{\text{?}} \vert ( {X}_{0} , {Γ}_{\text{?}} ) = {X}_{0} + {Γ}_{\text{?}} + {ϵ}_{t}^{′} , {ϵ}_{t}^{′} ∼ N ( 0 , {τ}_{\text{?}}^{′} ) . \qquad ( 6 )$$

$$\text{?} \text{indicates text missing or illegible when filed}$$

It should be noted that, different from equation (1), the noise ϵₜ^{t} must change over time as the covariance matrix Tₜ^{t} is time-varying when learning the cumulative difference.

From equation (6), it appears that the currently observed variable Xₜ only depends on the current information of Γₜ for any given starting census Xₒ. However, this is not the case as the correlations are encapsulated in all latent variables up to time t, as they drive the cumulative difference Γₜ. This becomes evident from the following recursive equations for Γₜ:

$${Γ}_{0} = {Δ}_{0} = {a}_{0} - {d}_{0} \qquad ( 7 )$$

$$\begin{matrix}{Γ}_{t} = {\sum }_{i = 1}^{\text{?}} {Δ}_{i} = {\sum }_{i = 1}^{\text{?} - 1} {Δ}_{i} + {Δ}_{t} = {Γ}_{t - 1} + \vert {Δ}_{t} \\ = {Γ}_{\text{?} - 1} + {b}_{Δ} ( {Δ}_{t - 1} ) + {σ}_{Δ} {Z}_{\text{?}}^{Δ} , t = 1 , … , T .\end{matrix}$$

$$\text{?} \text{indicates text missing or illegible when filed}$$

Note that equation (6) and (7) present an equivalent transformation of the original learning task, with the unknown parameters to be learned as the drift function b_{Δ}(·) and diffusion matrix σ_{Δ}.

The relationship presented in equations (6) and (7) reveals the complex temporal correlations. Due to interactions between inflow and outflow variables described in equations (2), (3), and (4), such complexity hinders any heuristic assumptions on correlation structures between Xₜ and X_{1:t-1}. However, by expanding equation (7), the correlation structure becomes clear. The difference variables Δ_{1:t-1} with the drift function b_{Δ}(·) contributes to Γₜ, demonstrating that the temporal correlations Xₜ and Xₜ₋₁ are also influenced by the sequence of difference Δ_{1:t-1}.

Furthermore, using equations (6) and (7), reconstructing Xₜ from Γₜ prevents error accumulation, as Γₜ is a cumulative difference and only needs the initial value Xₒ to reconstruct Xₜ, bypassing the recursive reconstruction in step-wise learning. By expanding equation (7), it becomes clear that Γₜ is driven by the latent variable sequence Z_{1:t}^{Δ}Therefore, the formation is essentially learning a mapping from the sequence of latent variables Z_{t:1}^{Δ}to the variable Γₜ. This means potential biases in the learned Γₜ₋₁ will not affect Γₜ learning since it is solely determined by latent variables. Meanwhile, as discussed, temporal correlations within sequences are not lost. This is because the dependence of Γₜ on Z_{1:t}^{Δ}naturally encodes temporal correlations between Γₜ₋₁ and Γₜ.

### Cumulative Difference Temporal Variational Autoencoder (DT-VAE)

Examples of the system and method us a VAE-based framework, DT-VAE, to learn equations (6) and (7). The details are as follows.

Evidence Lower Bound (ELBO). For any given Xₒ=xₒ, denote the observed sequence of cumulative difference variables Γ_{1:T} as γ_{1:T}={γ₁, . . . , ≡_{T}}. As from equation (7), Γₜ is driven by latent variables Z_{1:t}^{Δ}to the Z^{Δ} at each time step t={1, . . . , T}. Let z_{1:T}=(z₁, . . . , z_{T}) denote the sequence of prior variables from prior distribution p(z_{1:T}). To overcome the intractability of the likelihood function p_{θ}(γ_{1:T}), VAE optimize the evidence lower bound (ELBO) as the surrogate objective:

$$\begin{matrix}log {p}_{θ} ( {γ}_{1 : T} ) = log \int {p}_{θ} ( {γ}_{1 : T} , {z}_{1 : T} ) {dz}_{1 : T} \\ = log \int {p}_{θ} ( {γ}_{1 : T} , {z}_{1 : T} ) \frac{{q}_{ϕ} ( {z}_{1 : T} \vert {γ}_{1 : T} )}{{q}_{ϕ} ( {z}_{1 : T} \vert {γ}_{1 : T} )} {dz}_{1 : T} \geq \\ {𝔼}_{\text{?}} [ log ( \frac{{p}_{θ} ( {γ}_{1 : T} , {z}_{1 : T} )}{{q}_{θ} ( {γ}_{1 : T} , {z}_{1 : T} )} ) ] \\ = {𝔼}_{\text{?}} [ log ( \frac{{\prod }_{\text{?}}^{\text{?}} {p}_{θ} \text{?}}{{\prod }_{\text{?}}^{\text{?}} {q}_{θ} \text{?}} ) ] \\ = {\sum }_{t = 1}^{T} {𝔼}_{\text{?}} log {p}_{θ} ( {γ}_{t} \vert {z}_{1 : t} ) - \\ {𝔼}_{\text{?}} {D}_{KL} ( {q}_{ϕ} ( {z}_{\text{?}} \vert {z}_{\text{?}} , {γ}_{\text{?}} ) ‖ N ( 0 , I ) ) \\ = ℒ ( {γ}_{1 : T} ) .\end{matrix} \qquad ( 8 )$$

$$\text{?} \text{indicates text missing or illegible when filed}$$

Note that the joint distribution p_{θ}(γ_{1:T}, z_{1:T}) is the generative process for generating γ_{1:T}, and q_{ϕ}(z_{1:T}|γ_{1:T}) denotes the variational distribution with parameter ϕ that approximates the true posterior distribution. In some examples, an additional hyperparameter λ>0 is used in front of the KL term to further balance the two parts in ELBO. Next, the generative process p_{θ}(γ_{1:T}, z_{1:T}) and the variational distribution q_{ϕ}(z_{1:T}|γ_{1:T}) will be discussed separately.

### Decoder Design

For the generative process, the decoder of DT-VAE f_{θ}(·), parameterized by θ, decodes latent variables z_{1:t} to generate γₜ. In other words, the decoder f_{θ}(·) learns the conditional distribution p_{θ}(γₜ|z_{1:t}). Going forward, f_{θ}(z_{1:t}) and p_{θ}(γₜ|z_{1:t}) are used interchangeably and z^{prior} is used to denote samples from the prior distribution.

A key step in deriving the ELBO in equation (8), particularly from line 3 to line 4, is via the decomposition for p_{θ}(γ_{1:T}, z_{1:T}):

$$\begin{matrix}{p}_{θ} ( {γ}_{1 \text{?} T} , {z}_{1 \text{?} T} ) = {p}_{θ} ( {γ}_{1 \text{?} T} \vert {z}_{1 \text{?} T} ) p ( {z}_{1 \text{?} T} ) \\ = ( {\prod }_{t = 1}^{T} {p}_{θ} ( {γ}_{\text{?}} \vert {z}_{1 : \text{?}} ) ) p ( {z}_{1 : T} ) \\ = {\prod }_{t = 1}^{T} {p}_{θ} ( {γ}_{\text{?}} \vert {z}_{1 : t} ) {\prod }_{t = 1}^{T} p ( {z}_{\text{?}} \vert {z}_{1 : \text{?} - 1} ) ,\end{matrix} \qquad ( 9 )$$

$$\text{?} \text{indicates text missing or illegible when filed}$$

where p_{θ}(γₜ|z_{1:t}) denotes the approximation of the true conditional distribution p(γₜ|z_{1:t}) and p(zₜ|z_{1:t-1}) denotes the conditional prior distribution for latent variables zₜ.

From equation (9), an important assumption is made on the conditional distribution p_{θ}(γ_{1:T}|z_{1:T}) and prior distribution p(z_{1:T}). As previously mentioned, for each γₜ, it solely depends on latent variables z_{1:t} to avoid error accumulation. This essentially makes γₜ conditionally independent across different time steps given the latent variables z^{prior}. That is, for any two time steps w≠v≤T, the cumulative difference variable (γ_{w}|z_{1:w})⊥(γᵥ|z_{1:v}) are independent conditional on corresponding latent variables. This assumption is crucial, and allows the transformation from p_{θ}(γ_{1:T}|z_{1:T}) to the product form Πₜ₋₁^{T}p_{θ}(γₜ|z_{1:t}).|

Following the VAE literature, the conditional distribution is assumed to be p_{θ}(γₜ|z_{1:t}) ˜N(μ_{t, θ}, σ_{t,θ}) or a Gaussian distribution with a diagonal covariance matrix. It should also be noted that σ_{t,θ}is time-varying, as from equation (6). For the prior distribution, it is assumed that it is an independent Gaussian, namely, p(zₜ|z_{1:t-1})˜N(0, I). Though zₜ^{prior}'s are independent, the decoder f_{θ}still allows us to capture the underlying correlation via the relationship between γₜ and z_{1:t}^{prior}. The decoder is designed via a recurrent neural network (RNN) f_{θ}_{₁}, enclosing all time steps information z_{1:t}^{prior} recursively, with a feedforward network f_{θ}_{₂}, further transforming the input to μ_{t, θ}and σ_{t, θ}, or,

$${h}_{t , {θ}_{1}} = {f}_{{θ}_{1}} ( {h}_{t - 1 , {θ}_{1}} , {\text{?}}_{t} ) ( {μ}_{t , θ} , {σ}_{t , θ} ) = {f}_{{θ}_{2}} ( {h}_{t , {θ}_{1}} ) \qquad ( 10 )$$

$$\text{?} \text{indicates text missing or illegible when filed}$$

where h_{t, θ}_{₁} is the hidden state in the RNN structure f_{θ}_{₁}.

The decoder f_{θ}can be parameterized by any architecture, as long as the output γₜ depends on the latent variables z_{1:t}^{prior}, such as self-attention structures or temporal convolutions.

### Encoder Design

Next, the posterior distribution is described, which is also known as the encoder. DT-VAE learns an encoder f_{ϕ}(·) with parameter ϕ to encode observed γ_{1:t} into the variational (posterior) distribution q_{ϕ}(z_{1:T}|γ_{1:T}). In this formulation, fϕ(γ_{1:t}) and pϕ(z_{1:t}|γ_{1:t}) are used interchangeably. To distinguish between the two, this formulation denotes z^{post} for samples from the posterior distribution.

The posterior distribution qϕ(z_{1:T}|Γ_{1:T}) is factored as:

$${q}_{ϕ} ( {\text{?}}_{1 : T} \vert {γ}_{1 : T} ) = {\prod }_{t = 1}^{T} {q}_{ϕ} ( {z}_{t} \vert {z}_{1 : t - 1} , {γ}_{1 \text{?} t} ) \qquad ( 11 )$$

$$\text{?} \text{indicates text missing or illegible when filed}$$

During the training stage, zₜ^{post} is sampled from the posterior distribution qϕ(zₜ|z_{1:t-1}, γ_{1:t}) and the decoder reconstructs the observed γₜ's. For sampling from the posterior distribution, at each time step t, zₜ^{post} is sampled from the distribution conditioned on the historical posterior variables z_{1:t-1}^{post} and all observed γ_{1:t}.

Following the VAE literature, is it assumed that variational distribution 1_{ϕ}(zₜ|z_{1:t-1}, γ_{1:t})˜N (μ_{t,ϕ}, σ_{t,ϕ}), in other words, a Gaussian distribution with a diagonal covariance matrix, where the μ_{t,ϕ}and σ_{t,ϕ}are learned using the encoder f₉₉. To capture that the historical information relies on both z^{post}'s and γ's, the encoder f_{ϕ} is decomposed into three functions with parameters ϕ₁, ϕ₂, and ϕ₃:

$${h}_{\text{?} , {ϕ}_{1}} = {f}_{{ϕ}_{1}} ( {h}_{t - 1 , {ϕ}_{1}} , {γ}_{t} ) \qquad ( 12 )$$

$${μ}_{\text{?} , ϕ} = {f}_{{ϕ}_{2}} ( {h}_{t , {ϕ}_{1}} , {μ}_{t - 1 , ϕ} )$$

$${σ}_{t , ϕ} = {f}_{{ϕ}_{3}} ( {h}_{t , {ϕ}_{1} ,} {σ}_{t - 1 , ϕ} )$$

$$\text{?} \text{indicates text missing or illegible when filed}$$

where h_{t,ϕ}_{₁}, is the hidden state in RNN structure f_{ϕ}_{₁}. For each time step, h_{1, ϕ}_{₁} encodes all observed γ_{1:t}. The RNN structure f_{ϕ}_{₂} will output the mean of posterior distribution μ_{t,ϕ}by utilizing the h_{t,ϕ}_{₁}, and previous μ_{t-1, ϕ}. Therefore, for each time step, the current mean μ_{t, ϕ} contains information of previous means μ_{1:t-1, ϕ}, which resembles the conditional structure in q_{ϕ}(zₜ|z_{t:t-1}, γ_{1:t}) from equation (11). Similarly, the RNN structure f_{ϕ}, outputs σ_{t,ϕ}by utilizing h_{t,ϕ}_{₂} and σ_{t-1, ϕ} that contain prior information of γ_{1:t} and z_{1:t-1}^{post}.

Examples of the spatial-temporal predictive analytics system and method use the above described DT-VAE framework that is general, flexible, and can be integrated with various generative models. In some examples, the above DT-VAE framework can be paired with a variational autoencoder—generative adversarial network (VAE-GAN) for improved generative accuracy. These examples use an RNN-based discriminator network. Different from VAE-GAN, the examples of the spatial-temporal predictive analytics system and method still maintain the original reconstruction loss as in DT-VAE.

### Tiered Integration of Queuing Structure for Hourly Forecasts

Examples of the hourly forecast model 180 differ from the monthly/quarterly forecast model 170 and the weekly/daily forecast model 175 in the following two aspects. First, the way in which the hourly forecast model 180 captures the underlying physics structure. For the hourly forecast model 180, the queuing network model 150 mirrors the physical movement and interaction of resources within examples of the system 100, providing a more realistic and practical understanding of resource flows. Moreover, the hourly forecast model 180 predicts bottlenecks and flow issues. By capturing the underlying physics, the hourly forecast model 180 can also more effectively identify potential bottlenecks and optimize the flow of resources, which is crucial for short-term operational efficiency.

Second, the hourly forecast model 180 includes utilizes real-time information. The hourly forecast model 180 has the major advantage in utilizing real-time data about the current location and movement of units. This immediate information is crucial for making accurate, timely predictions and decisions on an hourly basis. In addition, the hourly forecast model 180 includes dynamic system adaptation. Unlike generic AI algorithms, the hourly forecast model 180 adapts dynamically to real-time changes, adjusting predictions and recommendations based on the latest operational data.

By way of illustration, the hourly forecast model 180 was used to capture the physical system dynamics in a healthcare setting. In this context, the hourly forecast model 180 captures the movements of patients among different units (such as ICU and regular Medical-Surgical units) in a hospital. This mimics the physical flow of patients, reflecting their different stages of recovery process, in a real-world hospital setting.

Using Monte-Carlo simulation, the hourly forecast model 180 can predicts the number of patients in these units at different times. This prediction on the number of patients can further allow the prediction of resource demands (like bed occupancy, staff requirements) in real-time. This aid in efficient resource allocation and patient management. The hourly forecast model 180 can predict the number of patients with a high accuracy.

There are several benefits of the hourly forecast model 180. One benefit is transparency and predictability. The queuing network model 150 offers more transparency in how predictions are made, as opposed to the often opaque nature of deep learning algorithms. This transparency aids in trust and usability for decision-makers. Moreover, the queuing network model's 150 reliance on established physical principles ensures consistent and explainable results, which provides reliability for hourly decision-making.

The hourly forecast model 180 also has the benefits of customization and flexibility. The hourly prediction model 180 can be customized to reflect the specific dynamics of different operational environments, making it highly versatile. The hourly forecast model 180 is also flexible to handle a variety of scenarios, from regular operational flows to unexpected surges in demand, making it ideal for hourly adjustments. In particular, the hourly forecast model 180 can rapidly scale its predictions to meet urgent demands, a critical feature for hourly decision-making, especially in high-pressure environments like emergency services.

### Training the Queuing Network Model

The training of the queuing network model 150 combines historical patient flow data and real-time dynamic information. This training creates a more robust and adaptive spatial-temporal predictive analytics system and method.

First, the training regime establishes baseline scenarios with historical data. In the context of the healthcare setting, historical data provides the foundational patterns of patient admissions, movements, and discharges. This includes day-of-week trends and time-of-day patterns (such as peak times/days in patient arrivals and discharges), and average lengths of stay in different units across different patient categories. This historical data identifies “typical” patient flow scenarios, aiding formation of the baseline for future predictions. The training also uses historical data to train and learn the transfer/discharge model, or, in other words, when a patient is predicted to leave the current unit and transfer to another unit or leave the system.

Second, the training integrates real-time dynamic information. In the healthcare setting, real-time input data includes specific features of currently admitted patients, such as their up-to-date medical conditions, severity levels, and specific needs. This information helps the model understand the current composition of the patient population.

The training then uses this information to estimate the expected remaining length of stay for each patient. This estimated discharge information is combined to help predict the number of patients in each unit in the next few hours, accounting for the upcoming discharges and new admissions. This also helps to predict near-term resource requirements.

The training provides real-time adaptivity and responsiveness. The integration of real-time data enables the model to adjust its predictions based on current hospital conditions, such as sudden influxes of patients or changes in patient status. This continuous influx of real-time data enhances the predictive accuracy of the model, particularly for short-term, hourly decision-making.

The training also provides for continuous model refinement. The training and calibration employs a feedback loop, which in some examples is updated every 4-6 hours. The outcomes of predictions are analyzed against real-world results, enabling continuous refinement and improvement of the predictive algorithms. As the system and method evolve, the queuing network model 150 adapts, thus ensuring its predictions remain relevant and accurate over time.

By integrating a comprehensive array of data, both historical and real-time, the queuing network model 150 is a highly adaptive tool. This integration not only enhances the queuing network model's 150 predictive accuracy for short-term resource allocation but also ensures its long-term relevance when used in dynamic healthcare environments.

### Computer System

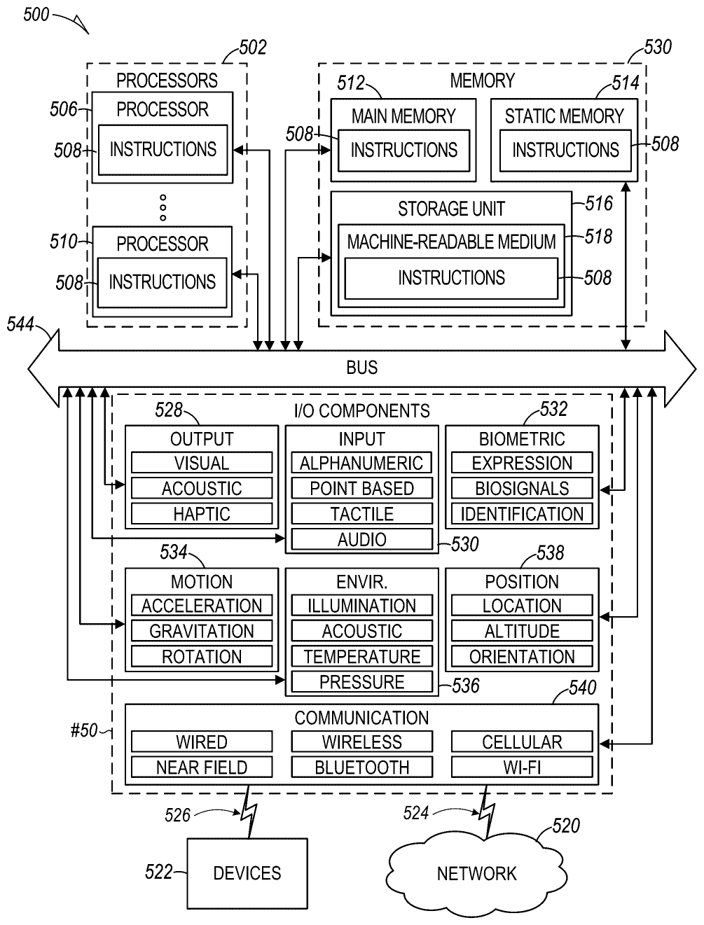

FIG. 5 illustrates a diagrammatic representation of a machine 500 in the form of a computer system within which a set of instructions may be executed for causing the machine to perform any one or more of the methodologies discussed herein, according to some examples of this disclosure. For example, the processing unit 120 shown in FIG. 1 may be embodied as machine 500.

Specifically, FIG. 5 shows a diagrammatic representation of the machine 500 in the example form of a computer system, within which instructions 508 (e.g., software, a program, an application, an applet, an app, or other executable code) for causing the machine 500 to perform any one or more of the methodologies discussed herein may be executed. The instructions 508 transform the general, non-programmed machine 500 into a particular machine 500 programmed to carry out the described and illustrated functions in the manner described. In alternative examples, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 508, sequentially or otherwise, that specify actions to be taken by the machine 500. Further, while only a single machine 500 is illustrated, the term “machine” shall also be taken to include a collection of machines 500 that individually or jointly execute the instructions 508 to perform any one or more of the methodologies discussed herein.

The machine 500 may include processors 502, memory 504, and I/O components 542, which may be configured to communicate with each other such as via a bus 544. In an example, the processors 502 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 506 and a processor 510 that may execute the instructions 508. The term “processor” is intended to include multi-core processors that may comprise two or more independent processors (sometimes referred to as “cores”) that may execute instructions contemporaneously. Although FIG. 5 shows multiple processors 502, the machine 500 may include a single processor with a single core, a single processor with multiple cores (e.g., a multi-core processor), multiple processors with a single core, multiple processors with multiples cores, or any combination thereof.

The memory 504 may include a main memory 512, a static memory 514, and a storage unit 516, both accessible to the processors 502 such as via the bus 544. The main memory 504, the static memory 514, and storage unit 516 store the instructions 508 embodying any one or more of the methodologies or functions described herein. The instructions 508 may also reside, completely or partially, within the main memory 512, within the static memory 514, within machine-readable medium 518 within the storage unit 516, within at least one of the processors 502 (e.g., within the processor's cache memory), or any suitable combination thereof, during execution thereof by the machine 500.

The I/O components 542 may include a wide variety of components to receive input, provide output, produce output, transmit information, exchange information, capture measurements, and so on. The specific I/O components 542 that are included in a particular machine will depend on the type of machine. For example, portable machines such as mobile phones will likely include a touch input device or other such input mechanisms, while a headless server machine will likely not include such a touch input device. It will be appreciated that the I/O components 542 may include many other components that are not shown in FIG. 5. The I/O components 542 are grouped according to functionality merely for simplifying the following discussion and the grouping is in no way limiting. In various examples, the I/O components 542 may include output components 528 and input components 530. The output components 528 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 530 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 542 may include biometric components 532, motion components 534, environmental components 536, or position components 538, among a wide array of other components. For example, the biometric components 532 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 534 may include acceleration sensor components (e.g., accelerometer), gravitation sensor components, rotation sensor components (e.g., gyroscope), and so forth. The environmental components 536 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 538 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 542 may include communication components 540 operable to couple the machine 500 to a network 520 or devices 522 via a coupling 524 and a coupling 526, respectively. For example, the communication components 540 may include a network interface component or another suitable device to interface with the network 520. In further examples, the communication components 540 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 522 may be another machine or any of a wide variety of peripheral devices (e.g., a peripheral device coupled via a USB).

Moreover, the communication components 540 may detect identifiers or include components operable to detect identifiers. For example, the communication components 540 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 540, such as location via Internet Protocol (IP) geolocation, location via Wi-Fi® signal triangulation, location via detecting an NFC beacon signal that may indicate a particular location, and so forth.

### Executable Instructions and Machine Storage

The various memories (i.e., memory 504, main memory 512, static memory 514, and/or memory of the processors 502) and/or storage unit 516 may store one or more sets of instructions and data structures (e.g., software) embodying or utilized by any one or more of the methodologies or functions described herein. These instructions (e.g., the instructions 508), when executed by processors 502, cause various operations to implement the disclosed examples.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data in a non-transitory manner and that can be read by one or more processors. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various examples, one or more portions of the network 520 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 520 or a portion of the network 520 may include a wireless or cellular network, and the coupling 524 may be a Code Division Multiple Access (CDMA) connection, a Global System for Mobile communications (GSM) connection, or another type of cellular or wireless coupling. In this example, the coupling 524 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 508 may be transmitted or received over the network 520 using a transmission medium via a network interface device (e.g., a network interface component included in the communication components 540) and utilizing any one of several well-known transfer protocols (e.g., hypertext transfer protocol (HTTP)). Similarly, the instructions 508 may be transmitted or received using a transmission medium via the coupling 526 (e.g., a peer-to-peer coupling) to the devices 522. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 508 for execution by the machine 500, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Additional Notes

The following, non-limited examples, detail certain aspects of the present subject matter to solve the challenges and provide the benefits discussed herein, among others.

Example 1 is a method for predictive analysis for forecasting resource demand, comprising: receiving input data containing information about previous resource demand; using a queuing network model including at least one queuing structure that captures physical movement of resource demand over time across different physical locations; integrating the at least one queuing structure into a generative artificial intelligence engine using a tiered integration approach having a plurality of integration tiers based on a forecast timescale to obtain a time-series generation and forecast model; and generating a forecast of resource demand using the time-series generation and forecast model.

In Example 2, the subject matter of Example 1 includes wherein the forecast timescale is a quarterly or monthly forecast timescale, and wherein the plurality of integration tiers is a monthly/quarterly integration tier, and further comprising minimally integrating at least one queuing structure into the generative artificial intelligence engine.

In Example 3, the subject matter of Examples 1-2 includes wherein the forecast timescale is a weekly or daily forecast timescale, and wherein the plurality of integration tiers is a weekly/daily integration tier, and further comprising moderately integrating the one or more queuing structure into the generative artificial intelligence engine.

In Example 4, the subject matter of Examples 1-3 includes wherein the forecast timescale is an hourly forecast timescale, and wherein the plurality of integration tiers is an hourly integration tier, and further comprising fully integrating the one or more queuing structure into the generative artificial intelligence engine.

Example 5 is a method of allocating resources, the method comprising: receiving input data containing relevant metrics about resource demand and resource capacity; processing the input data to obtain one or more queuing structures; integrating the one or more queuing structures into a predictive analytics technique using a tiered integration approach having an integration tier based on a forecast timescale; generating a forecast of resource demand over the forecast timescale and a recommendation for the allocation of resources across a plurality of physical locations from the input data and the one or more queuing structure using the predictive analytics technique; and presenting the forecast of resource demand and a recommendation for the allocation of resources across the plurality of physical locations.

In Example 6, the subject matter of Example 5 includes wherein the predictive analytics technique is a generative artificial intelligence technique.

In Example 7, the subject matter of Example 6 includes wherein the predictive analytics technique uses temporal variational auto-encoding (VAE) that leverages a cumulative difference learning mechanism, wherein the cumulative difference is a summation of the difference between an inflow of units and an outflow of units over the forecast timescale.

In Example 8, the subject matter of Examples 5-7 includes aggregating the input data into aggregate statistics including an inflow of units and an outflow of units over the plurality of physical locations.

In Example 9, the subject matter of Examples 5-8 includes using the predictive analytics technique to learn the allocation of resources from the input data; and using the one or more queuing structures to enhance an encoder design and a decoder design and to improve predictive power to capture complex spatial-temporal correlation, explainability, and interpolation for scenarios not observed in the past data; wherein the input data is spatially-temporally correlated across the plurality of physical locations.

In Example 10, the subject matter of Examples 5-9 includes forecasting resource demands across the plurality of physical locations over the forecast timescale, wherein the forecast timescale is at least one of: (a) a quarterly forecast timescale; (b) a monthly forecast timescale; (c) a weekly forecast timescale; (d) a daily forecast timescale; (e) an hourly forecast timescale.

Example 11 is a spatial-temporal predictive analytics system for directing allocation of resources, comprising: a data input system for processing input data from a plurality of physical locations; a generative artificial intelligence engine for learning patterns of resource demand from the input data using deep generative artificial intelligence techniques to generate a forecast of resource demands and a recommendation for the allocation of resources; one or more queuing structures integrated into the generative artificial intelligence engine using a tiered integration approach, the one or more queuing structures providing the generative artificial intelligence engine with simulations and predictions of a status of resources for a plurality of service stages across the plurality of physical locations; and an output system that presents the forecast of resource demands and the recommendations for the allocation of resources.

In Example 12, the subject matter of Example 11 includes a forecast model for integrating one or more queuing structures into the generative artificial intelligence engine across multiple forecast timescales.

In Example 13, the subject matter of Example 12 includes wherein the forecast model further comprises a monthly/quarterly forecast model for identifying monthly or quarterly patterns of resource demand across the plurality of physical locations.

In Example 14, the subject matter of Example 13 includes wherein the monthly/quarterly forecast model minimally integrates the one or more queuing structures into the generative artificial intelligence engine.

In Example 15, the subject matter of Examples 12-14 includes wherein the forecast model further comprises a weekly forecast model for identifying weekly patterns of resource demand across the plurality of physical locations.

In Example 16, the subject matter of Example 15 includes wherein the one or more queuing structures of the weekly forecast model further comprises inflow queuing structures, which identify the daily inflow of units over weeks to the plurality of physical locations, and outflow queuing structures, which identify the daily outflow of units over weeks from the plurality of physical locations, for enhancing a predictive power of the generative artificial intelligence engine and improving the recommendations for the allocation of resources.

In Example 17, the subject matter of Examples 12-16 includes wherein the forecast model further comprises an hourly forecast model for identifying hourly patterns of resource demand across the plurality of physical locations.

In Example 18, the subject matter of Example 17 includes wherein the hourly forecast model fully integrates the one or more queuing structures into the generative artificial intelligence engine.

In Example 19, the subject matter of Examples 12-18 includes wherein the generative artificial intelligence engine further comprises an encoder for breaking down the input data into its core components and using a cumulative difference learning mechanism to identify patterns across the plurality of physical locations and multiple forecast timescales.

In Example 20, the subject matter of Example 19 includes wherein the generative artificial intelligence engine further comprises a decoder for generating predictive data and the recommendations for the allocation of resources using the patterns across the plurality of physical locations and multiple forecast timescales.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Examples of the system and method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the examples of the invention disclosed herein without departing from the scope of this invention defined in the following claims.

The above-detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method for predictive analysis for forecasting resource demand, comprising:
receiving input data containing information about previous resource demand;
using a queuing network model including at least one queuing structure that captures physical movement of resource demand over time across different physical locations;
integrating the at least one queuing structure into a generative artificial intelligence engine using a tiered integration approach having a plurality of integration tiers based on a forecast timescale to obtain a time-series generation and forecast model; and
generating a forecast of resource demand using the time-series generation and forecast model.

2. The method of claim 1, wherein the forecast timescale is a quarterly or monthly forecast timescale, and wherein the plurality of integration tiers is a monthly/quarterly integration tier, and further comprising minimally integrating at least one queuing structure into the generative artificial intelligence engine.

3. The method of claim 1, wherein the forecast timescale is a weekly or daily forecast timescale, and wherein the plurality of integration tiers is a weekly/daily integration tier, and further comprising moderately integrating the one or more queuing structure into the generative artificial intelligence engine.

4. The method of claim 1, wherein the forecast timescale is an hourly forecast timescale, and wherein the plurality of integration tiers is an hourly integration tier, and further comprising fully integrating the one or more queuing structure into the generative artificial intelligence engine.

5. A method of allocating resources, the method comprising:
receiving input data containing relevant metrics about resource demand and resource capacity;
processing the input data to obtain one or more queuing structures;
integrating the one or more queuing structures into a predictive analytics technique using a tiered integration approach having an integration tier based on a forecast timescale;
generating a forecast of resource demand over the forecast timescale and a recommendation for the allocation of resources across a plurality of physical locations from the input data and the one or more queuing structure using the predictive analytics technique; and
presenting the forecast of resource demand and a recommendation for the allocation of resources across the plurality of physical locations.

6. The method of claim 5, wherein the predictive analytics technique is a generative artificial intelligence technique.

7. The method of claim 6, wherein the predictive analytics technique uses temporal variational auto-encoding (VAE) that leverages a cumulative difference learning mechanism, wherein the cumulative difference is a summation of the difference between an inflow of units and an outflow of units over the forecast timescale.

8. The method of claim 5, further comprising aggregating the input data into aggregate statistics including an inflow of units and an outflow of units over the plurality of physical locations.

9. The method of claim 5, further comprising:
using the predictive analytics technique to learn the allocation of resources from the input data; and
using the one or more queuing structures to enhance an encoder design and a decoder design and to improve predictive power to capture complex spatial-temporal correlation, explainability, and interpolation for scenarios not observed in the past data;
wherein the input data is spatially-temporally correlated across the plurality of physical locations.

10. The method of claim 5, further comprising forecasting resource demands across the plurality of physical locations over the forecast timescale, wherein the forecast timescale is at least one of: (a) a quarterly forecast timescale; (b) a monthly forecast timescale; (c) a weekly forecast timescale; (d) a daily forecast timescale; (e) an hourly forecast timescale.

11. A spatial-temporal predictive analytics system for directing allocation of resources, comprising:
a data input system for processing input data from a plurality of physical locations;
a generative artificial intelligence engine for learning patterns of resource demand from the input data using deep generative artificial intelligence techniques to generate a forecast of resource demands and a recommendation for the allocation of resources;
one or more queuing structures integrated into the generative artificial intelligence engine using a tiered integration approach, the one or more queuing structures providing the generative artificial intelligence engine with simulations and predictions of a status of resources for a plurality of service stages across the plurality of physical locations; and
an output system that presents the forecast of resource demands and the recommendations for the allocation of resources.

12. The spatial-temporal predictive analytics system of claim 11, further comprising a forecast model for integrating one or more queuing structures into the generative artificial intelligence engine across multiple forecast timescales.

13. The spatial-temporal predictive analytics system of claim 12, wherein the forecast model further comprises a monthly/quarterly forecast model for identifying monthly or quarterly patterns of resource demand across the plurality of physical locations.

14. The spatial-temporal predictive analytics system of claim 13, wherein the monthly/quarterly forecast model minimally integrates the one or more queuing structures into the generative artificial intelligence engine.

15. The spatial-temporal predictive analytics system of claim 12, wherein the forecast model further comprises a weekly forecast model for identifying weekly patterns of resource demand across the plurality of physical locations.

16. The spatial-temporal predictive analytics system of claim 15, wherein the one or more queuing structures of the weekly forecast model further comprises inflow queuing structures, which identify the daily inflow of units over weeks to the plurality of physical locations, and outflow queuing structures, which identify the daily outflow of units over weeks from the plurality of physical locations, for enhancing a predictive power of the generative artificial intelligence engine and improving the recommendations for the allocation of resources.

17. The spatial-temporal predictive analytics system of claim 12, wherein the forecast model further comprises an hourly forecast model for identifying hourly patterns of resource demand across the plurality of physical locations.

18. The spatial-temporal predictive analytics system of claim 17, wherein the hourly forecast model fully integrates the one or more queuing structures into the generative artificial intelligence engine.

19. The spatial-temporal predictive analytics system of claim 12, wherein the generative artificial intelligence engine further comprises an encoder for breaking down the input data into its core components and using a cumulative difference learning mechanism to identify patterns across the plurality of physical locations and multiple forecast timescales.

20. The spatial-temporal predictive analytics system of claim 19, wherein the generative artificial intelligence engine further comprises a decoder for generating predictive data and the recommendations for the allocation of resources using the patterns across the plurality of physical locations and multiple forecast timescales.
